(19) United States
(12) Patent Application Publication
(10) Pub. No.: US 2020/0070616 A1
(43) Pub. Date: Mar. 5, 2020

(54) ADJUSTABLE ROLL STABILIZER FOR A CHASSIS OF A MOTOR VEHICLE

(71) Applicant: ZF Friedrichshafen AG, Friedrichshafen (DE)

(72) Inventors: Rene SCHWARZE, Vörden (DE); Ulrich MAIR, Friedrichshafen (DE)

(21) Appl. No.: 16/467,176

(22) PCT Filed: Nov. 15, 2017
(86) PCT No.: PCT/EP2017/079256

§ 371 Date: Jun. 6, 2019

(30) Foreign Application Priority Data
Dec. 15, 2016 (DE) 10 2016 225 179.1

(51) Int. Cl. B60G 21/055

(52) U.S. Cl. CPC B60G 21/0553; B60G 2202/42; B60G 2202/135; B60G 2206/427

(57) ABSTRACT

An adjustable roll stabilizer (9), for a chassis of a motor vehicle, having an actuator (13) arranged between two partial sections (10,11) of a stabilizer. The actuator has an actuator housing (20) and an output (21) and is designed to produce a torsional moment acting between the two partial sections. A damping element (23,25) is arranged outside of the actuator.

This application is a National Stage completion of PCT/EP2017/079256 filed Nov. 15, 2017, which claims priority to German patent application serial no. 10 2016 225 179.1 filed Dec. 15, 2016.

### FIELD OF THE INVENTION

The invention relates to an adjustable stabilizer for a chassis of a motor vehicle, with an actuator arranged between two part-sections of a stabilizer, which actuator serves to produce a torsional moment that acts between the part-sections and is connected to at least one of the part-sections by way of an interposed damping element.

### BACKGROUND OF THE INVENTION

In the chassis of motor vehicles, the wheels or wheel suspensions of each axle are connected by way of stabilizers to one another and to the body of the vehicle, in order, particularly, when driving round a curve, to reduce the tendency of the vehicle body to roll because of transverse accelerations, i.e. the sideways tilting of the vehicle body toward the outside of the curve. When the wheel suspension is compressed on one side relative to the vehicle body as the motor vehicle drives round a curve, the stabilizer in the form of a torsion bar spring, which is connected at its ends to the wheels or wheel suspensions, produces a copying movement at the opposite wheel or wheel suspension. This results in reduced sideways tilting. By selective anti-roll supports on the front and rear axles of the motor vehicle its self-steering behavior can be improved.

When a wheel or wheel suspension is compressed on one side, for example due to a pothole or a bump in the road, the copying function of the roll stabilizer has the effect of producing a rolling movement of the vehicle.

By virtue of an actuator, which is arranged between two part-sections of a split stabilizer and can rotate these relative to one another, additional selective stabilizing torques can be produced which result in an active change of rolling movements and hence to optimization of the self-steering and load-change behavior of the chassis. In such cases the actuator often consists of an electronically regulated swivel motor, usually in the form of a hydraulic motor or an electric motor connected to transmission gearing. The adjustment produced at the part-sections of the stabilizer is continuously adapted to the driving situation at the time, so that the sideways tilt of the vehicle body can be reduced or a rolling movement decreased.

An adjustable roll stabilizer of the type indicated in the preamble of the independent claim is known from DE 10 2014 208 803 A1 In that case a damping unit is arranged between an output shaft of a transmission of an actuator and a part-section of the stabilizer. To form this damping unit the output shaft is connected to an outer star which transmits the torsional moment produced by the actuator to an inner star arranged on the corresponding end of the part-section. When one of the stars is rotated the damping material of the stars is loaded in shear and yields elastically until the flanks of the two stars come into contact against one another. Furthermore, the damping material can also be arranged between the tooth flanks of the inner and outer stars. The damping unit is arranged inside the actuator housing of the actuator. Excitations in the form of vibrations due to the movements of the wheel can thus reach the housing unimpeded by way of a part-section, and produce annoying noise.

### SUMMARY OF THE INVENTION

Starting from the relevant prior art the influence of vibrations on the part of the wheels or wheel suspensions on the actuator should be reduced.

The present invention is distinguished by the features of the characterizing portion of the independent claim(s). Advantageous design features are indicated in particular by the dependent claims, which can in each case stand alone or can represent an aspect of the invention in various combinations with one another.

An adjustable roll stabilizer for a chassis of a motor vehicle comprises an actuator arranged between two part-sections of a stabilizer, which serves to produce a torsional moment that acts between the part-sections and thus to rotate them relative to one another in one direction or the other. The roll stabilizer connected at its ends to the wheel suspensions and mounted on the chassis or the vehicle body is accordingly divided into part-sections, with the actuator connected between them. The actuator is connected to at least one of the part-sections of the stabilizer by way of at least one interposed damping element, with this damping element arranged outside the actuator.

Perturbing influences caused by the wheels or wheel suspensions and induced in the roll stabilizer, such as vibrations, therefore advantageously do not act directly on the actuator since they are reduced by the at least one damping element.

In relation to the longitudinal axis of the actuator the at least one damping element is designed to damp both rotationally acting and axially acting perturbing influences. Thus, the effect of the damping element is that impacts and to some extent high-frequency vibratory excitations, for example caused by unevenness of the road, are transmitted directly and undiminished via the wheels or wheel suspension and the part-sections of the stabilizer to the actuator. These vibratory excitations can generate conspicuous noise effects in the actuator and, there, primarily in a gear system. Besides improving the acoustic properties this arrangement also has positive effects on the life and the wear of the actuator components. The prerequisite for this is that there should be no direct connection between any structural element (housing or drive output) of the actuator and the part-section of the stabilizer. Here, the degree of damping can be influenced by the hardness or strength of the damping element, according to requirements.

If during the production of the adjustable roll stabilizer the actuator is made as a preassembled unit, then a connection can be made between the actuator and the part-section of the stabilizer concerned in the area of the at least one damping element outside the actuator housing during the fitting of the components to the vehicle or chassis. A connection between the part-section and the actuator housing and drive output, which is usually produced by a weld joint, can therefore be replaced.

In the context of the invention an “actuator” is understood to mean an assembly which comprises at least one motor accommodated in the actuator housing, which motor is provided for producing a torsional moment. The motor is preferably a swivel motor and can be in the form of a hydraulic motor or preferably an electric motor. Particularly in the latter case transmission gearing is provided inside the actuator housing. The transmission gearing is driven by the rotor of the electric motor and preferably has one or more gear ratios, particularly in the form of one or more planetary gear steps. The drive movement of the motor, which has a comparatively low torque, is thus converted so that a large torque is produced at the drive output of the transmission outlet of the actuator, which acts upon the part-section connected to the drive output. As mentioned earlier, the part-section is preferably connected to the drive output via a damping element, Preferably a transmission ratio i of around 200 can be chosen. The actuator is preferably positioned approximately in the middle of the length of the vehicle axle concerned, with the longitudinal axis of the actuator preferably parallel to the axis of the vehicle.

The damping element comprises at least one elastic element, which is arranged between the respective part-sections and the actuator. Preferably however, the damping element is understood to be not an individual, separate component, but an area that connects the actuator and the part-section of the roll stabilizer concerned. At the respective end of the part-section there are the at least one elastic element, the respective end of the actuator and a securing element which delimits the area of the damping element in its extension.

In the context of the invention the respective part-sections of the stabilizer can each be in the form of a torsion bar, which are approximately parallel to the axis of the vehicle, To the side of the actuator a mounting is provided on the chassis or the vehicle body. To the side of the mounting the part-sections are preferably bent in the direction of the wheels or wheel suspension and at the end of the part-sections are connected to the wheels or wheel suspensions, preferably by means of a control arm and joints. The individual part-sections can be made from solid material or in the form of tubular components.

According to a further possible design of the invention the at least one damping element is provided between at least one structural element of the actuator, which is in the form of the actuator housing and/or a drive output, also called a drive output element or drive output shaft, and the corresponding part-section of the stabilizer. The at least one structural element can be connected to the corresponding part-section in both the circumferential and the axial direction at least partially with interlock and/or by friction and/or in a material-merged manner. The damping element is designed in such manner that an elastic element is arranged between the surfaces of the structural element and the part-section that face one another. Various embodiments of such a connection of the structural element and the part-section are possible. The surfaces are preferably arranged parallel to one another. They can for example be flat or follow a contour which, viewed in cross-section, forms a waveform (like a sine curve, a triangle or rectangular curve or a combination thereof). The structural element and the part-section of the stabilizer can be made complementary to one another such that their surfaces facing one another, between which the elastic element is provided, have corresponding shapes.

In this case the elastic element can be made from an elastomer material or else some other elastic material, or even as one or more energy-stores for example in the form of springs. Furthermore the elastic element can be vulcanized onto one or both surfaces, or fixed in some other way, or even just positioned between them.

In addition, from a first one of the surfaces between which the elastic element is held, a stop element projecting above the surface should extend, which ends a distance away from a second one of the surfaces. The purpose of this stop is that when the actuator is actuated by the torsional moment a deformation path corresponding to the distance is exceeded. In other words, the stop is intended to prevent the interposed elastic element from being overloaded or even destroyed.

In a further development of the above arrangement, in the area where they are connected or in the area where the damping element extends, the structural element of the actuator and the part-section of the stabilizer together form a polygonal or cylindrical or conical outer contour. Moreover the cylindrical contour is surrounded by clamping means which enclose the structural element and the part-section with interlock and connects them firmly to one another in a rotationally fixed manner, but in particular so that they can be separated (for example, for maintenance purposes). In the area where the for example complementary undulating surfaces are provided, the structural element and/or the part-section can be made from solid material or as a tubular element.

Preferably the damping means can be provided on its inner enveloping surface with an elastic material, so that in particular radially, vibrations and impacts are transmitted via the damping means from the part-section to the structural element of the actuator concerned. As also provided, the damping means can be in the form of a sleeve. This sleeve is provided on its inside enveloping surface with an elastic material such as an elastomer. Furthermore, it is also possible to make the sleeve itself from an elastic material. The sleeve can, respectively, be fitted onto the structural element or the part-section of the stabilizer on one side with a press fit and on the other side with a transition fit. Instead of the transition fit the sleeve can also be shrink-fitted on. It is also possible to press-fit the sleeve on the drive output shaft of the transmission and to provided a transition fit between the sleeve and the part-section of the stabilizer. On the other hand, the use of the press fir and the transition fit can be provided in the reverse order.

Alternatively or in addition, on one side, i.e. either to the structural element or to the part-section concerned, the sleeve can be connected with interlock and/or in a material-merged manner, preferably by welding.

According to a further embodiment of the invention the clamping element can also be in the form of a clamp that can be screwed on, which can besides serve to mount the part-section of the stabilizer onto an axle body. Here, a clamp is a connection possibility made in one or more pieces, which in the area of the damping element must be adapted to fit. The clamp is for example designed as a releasable tubular shell. The areas that overlap can be brought together in the clamp, wherein both the structural element of the actuator and the corresponding part-section of the stabilizer are inserted into the clamp in which they can rotate. As a further alternative, a design of the clamping element as a half-shell, such as a hinge, is also conceivable.

Alternatively, it is possible for the interlocked connection between the structural element concerned and the corresponding part-section to be in the form of a bolt passing radially through them, which is arranged between receiving bores in the structural element and the corresponding part-section and the bolt, Consequently, to produce the elastic connection receiving bores aligned with one another are provided, for example in the drive output shaft of the transmission and in the part-section which partially surrounds it. In these through-going receiving bores a sleeve made of an elastic material can be inserted, through which in turn a bolt is guided. This type of connection can also be made with a plurality of bolts and sleeves, for example offset from one another in the axial direction.

Alternatively, a damping element can in addition be arranged inside the actuator housing, preferably arranged between the motor and the transmission and/or the drive output element. In that way additional vibrations inside the actuator, for example caused by flank impacts of the transmission, can be reduced.

The invention is not limited to the indicated combinations of features in the independent and the dependent claims. There are also further possibilities for combining individual features with one another, in particular provided that they emerge from the claims, the following description of example embodiments, or directly from the figures.

### BRIEF DESCRIPTION OF THE DRAWINGS

To explain the invention further, reference is made to the following description of preferred embodiments of the invention. The figures show:

FIG. 1: A schematic representation of a front view of a chassis fitted with an adjustable roll stabilizer in a passenger car,

FIG. 2: A longitudinal section through an actuator of the roll stabilizer,

FIG. 3: A longitudinal section through a first arrangement according to the invention, of a damping element between a structural element that transmits a torsional moment and a part-section of a stabilizer, with undulating surfaces formed between them, and

FIG. 4: A longitudinal section through a second arrangement according to the invention, of a damping element between a structural element that transmits a torsional moment and a part-section of a stabilizer, wherein an interlocked connection is produced between the structural element concerned and the corresponding part-section in the form of a radially through-going bolt.

### DETAILED DESCRIPTION OF THE PREFERRED EMBODIMENTS

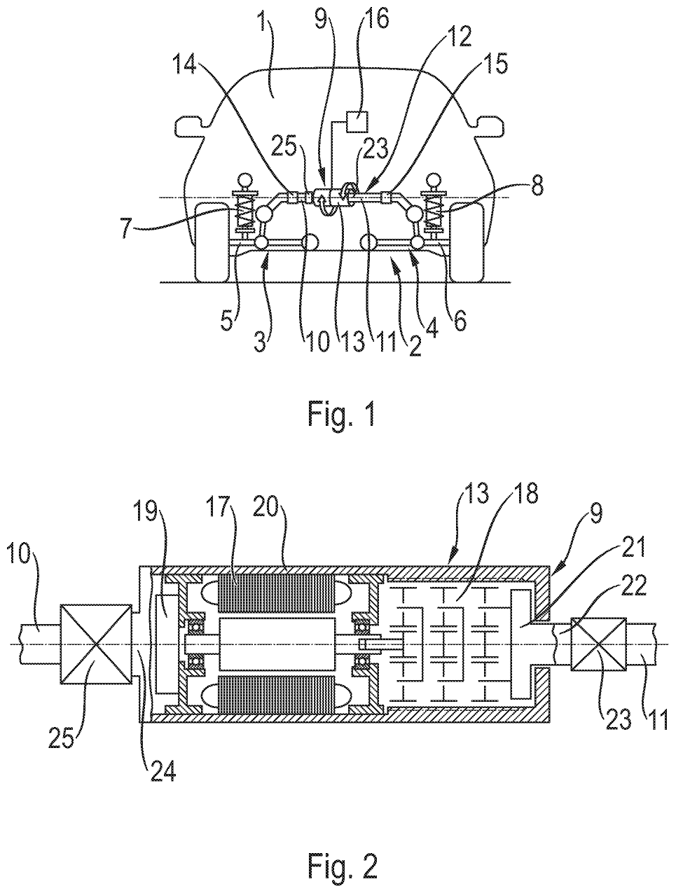

FIG. 1 shows a vehicle body 1 of a motor vehicle having a chassis 2. The chassis 2 has wheel suspensions 3 and 4, whose control arms 5 and 6 are supported on the vehicle body 1 by suspension struts 7 and 8. As can also be seen from the figure, an adjustable roll stabilizer 9 engages at its ends with the wheel suspensions 3 and 4. The stabilizer is, in this case, a stabilizer 12 divided into two part-sections 10 and 11, with an actuator 13 arranged between the part-sections 10 and 11.

By means of the actuator 13 different torsional moments can be produced between the part-sections 10 and 11, whereby depending on the driving conditions of the passenger car forces and torques occurring between the vehicle body 1 and the chassis 2 can be varied. Each of the part-sections 10 and 11 is guided and able to rotate on the vehicle body 1 by virtue of respective bearings 14 and 15 on the body. A control unit 16, to which any desired measurement values such as a transverse acceleration or a wall angle are transmitted, is connected to the actuator 13.

FIG. 2 shows a longitudinal section of the actuator 13. This comprises an electric motor 17 and a multi-gear planetary gearset 18. These structural elements are arranged inside an actuator housing 20. On the drive output side a drive output element 21 of the planetary gearset 18 is connected to the part-section 11 with a drive output shaft 22 via a first damping element 23 for damping both rotary and axial vibrations. At its end remote from the part-section 11 the actuator 20 has an attachment 24 which is connected via a second damping element 25 to the part-section 10. This damping element 25 too contributes toward damping both rotary and axial vibrations. It is also possible to provide a damping element 23 or 25 only on the drive output shaft 22 or on the attachment 24.

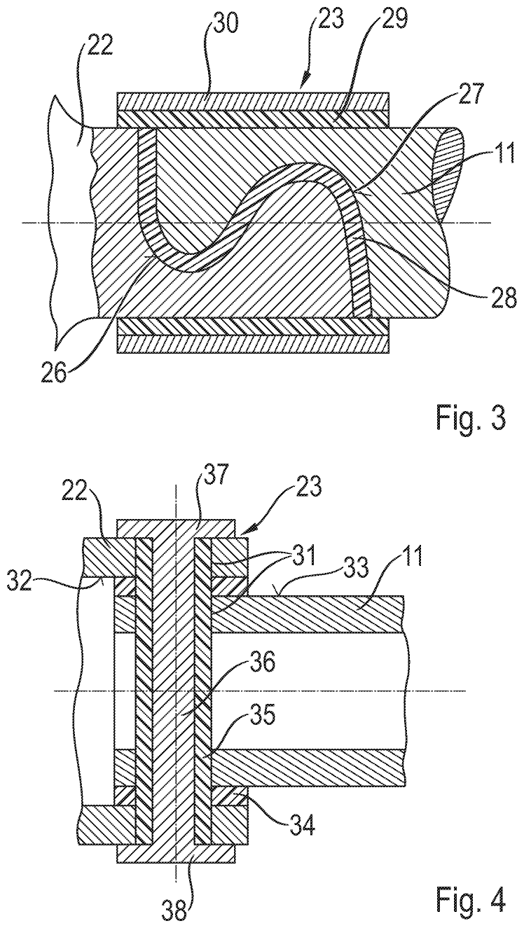

FIG. 3 shows a sectioned representation of a first preferred example embodiment of the invention, in which the drive output shaft 22 forms an undulating surface 26 over an area of its longitudinal extension owing to a recess. Between this undulating surface 26 of the drive output shaft 22 and an undulating surface 27 of the part-section 11 complementary thereto, is arranged a first elastic element 28 that is adapted to these contours, this being in the form of an elastomer element. It can be vulcanized onto both surfaces 26 and 27 or only onto one of the surfaces 26 and 27, or even just held between the two surfaces 26 and 27.

At least in the area in which the two aforesaid undulating surfaces 26 and 27 are located, the drive output shaft 22 and the part-section 11 are surrounded by a second elastic element 29, preferably in the form of an elastomer element, and a sleeve 30 that encloses it. By virtue of the aforesaid contours the two components, the drive output shaft 22 and the part-section 11, can be fitted into one another with the elastic element 28 between them. The sleeves 29, 30 previously pushed onto the part-section 11 are then with the second elastic element 29 pushed over the joint in order to complete the damping element and to connect the components firmly to one another in a rigid manner.

This joint can transmit both axial and radial as well as rotational forces. The sleeve 30 secures the joint. The first elastic element 28 damps axial and rotary vibrations and impacts between the two interlocking partners. Furthermore, the second elastic element 29, which is arranged between the sleeve 30 and the components, damps radial movements mainly transmitted from the corresponding part-section 10 of the stabilizer 12. In this case it is possible to supply the actuator 13 as a preassembled unit without supplying the part-sections 10 and 11 of the stabilizer 12, and only to combine them during the fitting of the roll stabilizer 9 to the axle.

Finally, FIG. 4 shows an embodiment in which the drive output shaft 22 and the part-section 11 are in each case tubular and are fitted concentrically with one another. In this case the two components have an aligned through-going bore 31. Between an inner casing surface 32 of the drive output shaft 22 and an outer casing surface 33 of the part-section 11 is arranged a first cylindrical elastic element 34. In addition, a second elastic element 35, in the form of a sleeve, passes through the through-going bore 31 and receives on its inside a bolt 36 which, at its ends, is fixed on the drive output shaft 22 by means of bolt-heads 37 and 39. In this case too the interlocked connection formed by the radial through-bore 31 and the bolt 36 can transmit both rotary and axial forces. Vibrations introduced by the part-section 11 are effectively damped by the damping element 23 formed by the two elastic elements 34 and 35.

### INDEXES

1 Vehicle body
2 Chassis
3 Wheel suspension
4 Wheel suspension
5 Control arm
6 Control arm
7 Suspension strut
8 Suspension strut
9 Adjustable roll stabilizer
10 Part-section
11 Part-section
13 Actuator
14 Bearing on the body
15 Bearing on the body
16 Control unit
17 Electric motor
18 Planetary gearset
19 Rotation angle sensor
20 Actuator housing, structural element
21 Drive output element
22 Drive output shaft
23 Damping element
24 Undulating attachment
25 Damping element
26 Undulating surface
27 Undulating surface
28 Elastic element
29 Elastic element
30 Sleeve
31 Through-going bore
32 Inner casing surface
33 Outer casing surface
34 Elastic element
35 Elastic element
36 Bolt
37 Head of 36
38 Head of 36

1-10. (canceled)

11. An adjustable roll stabilizer (9) for a chassis (2) of a motor vehicle, the roll stabilizer comprising:
an actuator (13) being arranged between two partial-sections (10, 11) of a stabilizer (12), and actuator having an actuator housing (20) and a drive output element (21);
the actuator serving to produce a torsional moment acting between the two partial-sections (10, 11); and
at least one damping element (23, 25) being arranged outside the actuator (13).

12. The adjustable roll stabilizer according to claim 11, wherein the at least one damping element (23, 25) is formed by an elastic element (28, 29) for damping both rotary and axial perturbing influences.

13. The adjustable roll stabilizer according to claim 11, wherein the at least one damping element (23, 25) is provided between at least one structural element (20) of the actuator (13), which is in a form of at least one of the actuator housing (20) and the drive output element (21), and the corresponding partial-section (10, 11), and the at least one structural element (20) is connected to the corresponding partial-section (10, 11), in both a circumferential direction and an axial direction, by at least one of interlocking, frictional and material-merged means, and an elastic element (28; 35) of the damping element (23, 25) is arranged between surfaces (26, 27, 31) of the structural element (20) concerned and the corresponding partial-section (10, 11) that face one another.

14. The adjustable roll stabilizer according to claim 11, wherein the damping element is formed of at least one elastic element (28, 29, 34, 35) and a securing element (30, 36) and facing ends of the two partial-sections (10, 11).

15. The adjustable roll stabilizer according to claim 14, wherein a structural element and the two partial-sections (10, 11) of the stabilizer (12), in an area of their connection with one another, are made complementary to one another, and their surfaces (26, 27) facing toward one another, in which the elastic element (28) of the damping element (23, 25) is located, have shapes that correspond with one another.

16. The adjustable roll stabilizer according to claim 15, wherein the structural element of the actuator (13) concerned and the two partial-sections (10, 11) of the stabilizer (12), in an area of their connection with one another, form a cylindrical outer contour and the surfaces (26, 27) of the two part sections, facing toward one another a longitudinal direction, have undulating shapes, and a cylindrical outer contour of the two partial-sections is surrounded by a clamping element in a form of either a sleeve or a shell.

17. The adjustable roll stabilizer according to claim 16, wherein the sleeve (30) is fitted over the structural element (22, 24) or the two partial-sections (10, 11) of the stabilizer (12), respectively, by a press fit, on one side, and by a transition fit, on the other side.

18. The adjustable roll stabilizer according to claim 17, wherein the clamping element is in the form of a shell which also serves to mount the two partial-sections of the stabilizer to an axle body.

19. The adjustable roll stabilizer according to claim 14, wherein an interlocked connection, between the structural element (22, 24) concerned and the corresponding partial-section (10, 11), is in a form of a bolt (36) passing therethrough, and the elastic element (35) is arranged through respective through-bores (31) in the structural element (22, 24) concerned and the corresponding partial-section (10, 11) and the bolt (36).

20. The adjustable roll stabilizer according to claim 11, wherein a damping element is also arranged inside the actuator housing (20) and positioned between a motor (17) and at least one of a transmission (18) and the drive output element (22).

21. An adjustable roll stabilizer for a chassis of a motor vehicle, the roll stabilizer comprising:
an actuator having an actuator housing and a drive output element being arranged between first and second partial-sections of a stabilizer;
the actuator producing a torsional moment acting between the first and the second partial-sections of the stabilizer; and
a damping element being arranged outside the actuator housing and coupling the drive output element of the actuator to the second part-section of the stabilizer.
